(19) United States
(12) Patent Application Publication
(10) Pub. No.: US 2024/0388774 A1
(43) Pub. Date: Nov. 21, 2024

(54) IMAGING ALTERATION DEVICE AND METHOD OF ALTERING AN IMAGE

(71) Applicant: William Chase, Avon, CT (US)

(72) Inventor: William Chase, Avon, CT (US)

(21) Appl. No.: 18/317,293

(22) Filed: May 15, 2023

(51) Int. Cl. H04N 23/20; H04N 23/10; H04N 23/56

(52) U.S. Cl. CPC H04N 23/20; H04N 23/10; H04N 23/56

(57) ABSTRACT

An imaging alteration device for incorporating details in images generated by an image capturing/generating device and/or for interfering with facial recognition processing of images captured by the image capturing/generating device. The details are incorporated into the images by generating and directing non-visible spectrum light to be captured by the image capturing generating device.

### TECHNICAL FIELD

The present disclosure generally relates to imaging alteration devices and, in particular, to devices that generate light not visible to humans but detectable by various image detectors such as, for example, cameras.

### BACKGROUND

Many people capture images during various activities and share those images peer-to-peer directly (e.g. through text messages, emails, etc.) and/or through one or more social networks. For example, people use their personal or work-issued cell phones that have one or more cameras for capturing images of food, people, places, animals, etc. There exists opportunities to insert branding and/or messaging on various objects found in these images.

Further, cameras are often used for security purposes at various venues such as, for example, schools, malls, movie theaters, sporting arenas, casinos, etc. in order to monitor students, employees, contractors, customers, visitors, and the like. More frequently as of late, facial recognition systems and methods are used in conjunction with one or more of the security cameras to detect and identify those people present at the venue. The identification of the people using the facial recognition can be used for tracking purposes to determine when each person visits the venue, how often and for how long. Some people are desirous of remaining anonymous when attending these venues and would prefer not to be tracked or identified when visiting these venues.

### SUMMARY

In some embodiments according to the present disclosure, a method of altering an image includes generating non-visible spectrum light, directing the non-visible spectrum light towards a subject to form a pattern on the subject, which is in the detection range of imaging devices.

In some embodiments, an imaging alteration method includes generating non-visible spectrum light, and directing the non-visible spectrum light from an article of clothing of a user.

In some embodiments, an imaging alteration method includes generating non-visible spectrum light, and directing the non-visible spectrum light from a worn device of a user such as a watch, pendant, bracelet or headwear.

In some embodiments, an imaging alteration device includes an article of clothing, a battery connected to the clothing, and a light source electrically connected to the battery. The light source is configured to generate non-visible spectrum light.

An imaging alteration device includes a housing, a mount connected to the housing configured to arrange and position the housing in a desired position and orientation, a battery or a power source connected to the housing, a light source arranged within the housing configured to generate non-visible spectrum light, the light source configured to be powered by the battery or the power source, a processor operatively connected to the light source, the processor configured to cause the light source to project the non-visible spectrum light in a pattern on a subject. The processor is configured to select the pattern from a plurality of possible patterns based on instructions received from local memory, local removable memory, and/or wireless signals.

Objects, features and advantages of the present invention will become apparent in light of the description of embodiments and features thereof, as enhanced by the accompanying figures.

### BRIEF DESCRIPTION OF THE DRAWINGS

FIG. 1 is a schematic diagram of an imaging alteration device in accordance with the present disclosure;

FIG. 2 is a schematic diagram of an imaging alteration device in accordance with the present disclosure;

FIG. 3 is a schematic diagram of an imaging alteration device in accordance with the present disclosure;

FIG. 4 is a schematic diagram of an imaging alteration device in accordance with the present disclosure;

FIG. 5A is a schematic diagram of the imaging alteration device of FIG. 4 connected to an article of clothing;

FIG. 5B is an image as captured and generated by an image capturing/generating device with altering made by the imaging alteration device of FIG. 5A in operation;

FIG. 6A is a diagram of an imaging alteration device in use by a user in accordance with the present disclosure;

FIG. 6B is a diagram of the imaging alteration device of FIG. 6A showing a different view;

FIG. 6C is a diagram of an imaging alteration device in use by a user in accordance with the present disclosure;

FIG. 6D is a diagram of the imaging alteration device of FIG. 6C showing a different view;

FIG. 6E is a diagram of an imaging alteration device in use by a user in accordance with the present disclosure;

FIG. 6F is a diagram of the imaging alteration device of FIG. 6E showing a different view;

FIG. 7 is a schematic diagram of an imaging alteration device in accordance with the present disclosure;

FIG. 8 is a flow diagram of a method of altering an image in accordance with the present disclosure; and

FIG. 9 is a flow diagram of a method of altering an image in accordance with the present disclosure.

### DETAILED DESCRIPTION

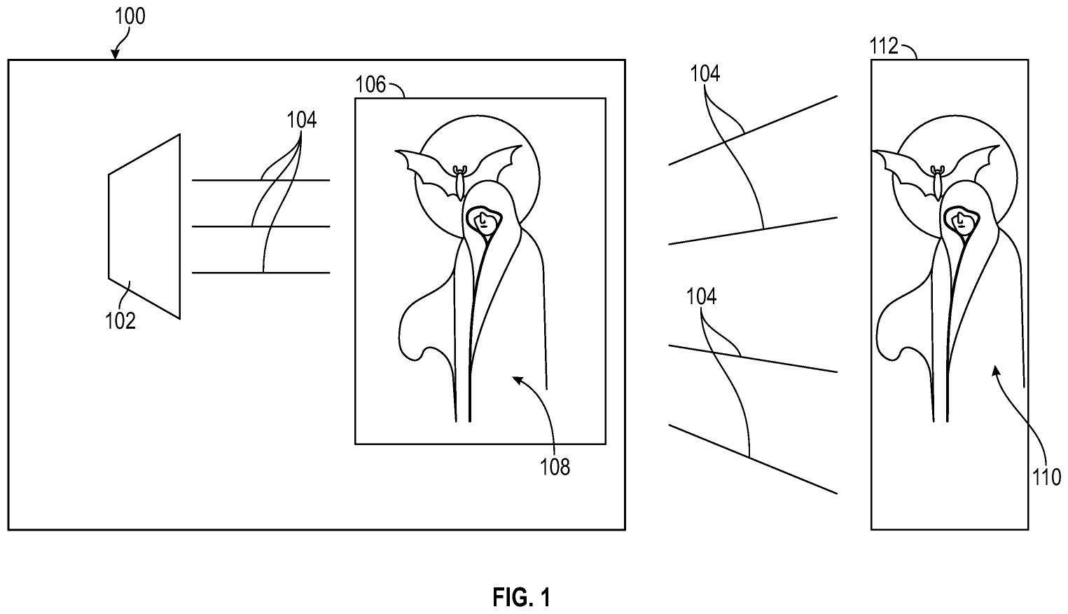

Referring to FIG. 1, a schematic diagram of an imaging alteration device 100 is shown in accordance with the present disclosure. The device 100 includes a light source 102 and a lighting gobo 104. The light source 102 is configured to generate light 104 in a spectrum not visible to the human eye. For example and without limitation, the light source 102 is configured to generate light 104 in the ultraviolet spectrum (e.g. light having a wavelength in the range of 10-400 nm) and/or infra-red spectrum (e.g light having a wavelength in the range of 700-1,000 nm). The gobo 106 includes and/or defines a design 108 that shapes and controls the light 104 that passes through the gobo 106 such that the light 104 that passes through the gobo 106 forms a pattern 110 when the light 104 strikes an object 112. The pattern 110 essentially corresponds to the aesthetics of the design 108 of the gobo 106. Since the light 104 is of a spectrum that is not in the visible light spectrum (the visible light spectrum being ˜380-700 nm), the pattern 110 formed on the object 112 is not visible to the typical human eye.

The device 100 of FIG. 1 may be referred to as a “static” imaging alteration device 100 since the gobo is fixed or “static” and, thus, the aesthetic design of the pattern 110 formed on the object 112 is fixed. The size of the pattern 110 could of course be adjusted by normal optical adjustments such as changing the distance between the device 100 and the object 112 and/or by adjusting a lens (not shown) at the output of the device 100. The pattern 110 can also be generated without a lens, for example, via a pinhole (e.g. camera obscura).

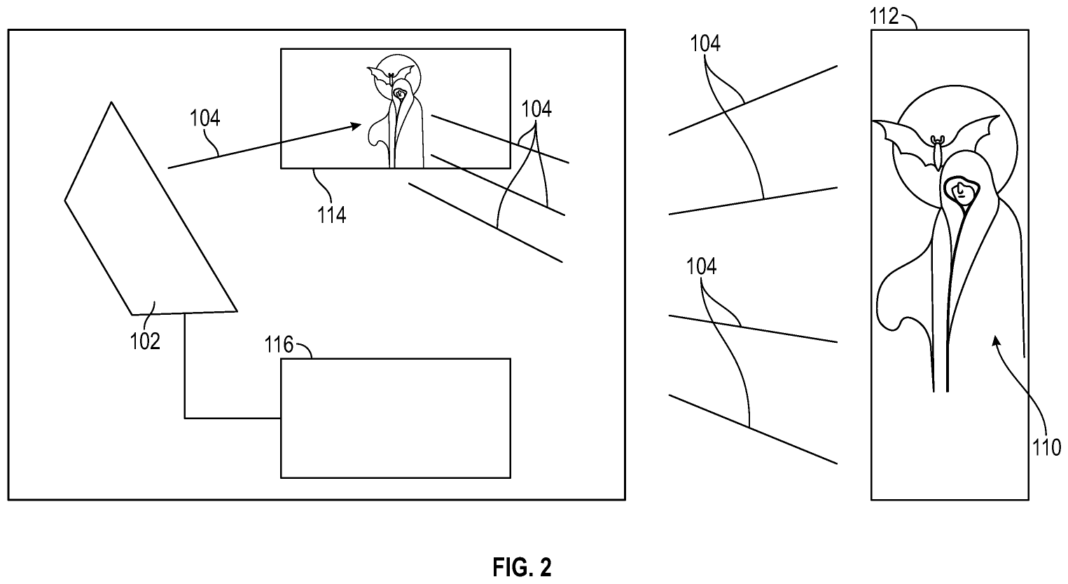

Referring to FIG. 2, a schematic diagram of an imaging alteration device 100 is shown in accordance with the present disclosure. Similar to the device 100 of FIG. 1, the device 100 of FIG. 2 includes a light source 102 configured to generate light 104 in a spectrum not visible to the human eye. The device 100 further includes a microelectromechanical systems (“MEMS”) mirror array, LCD, or other changeable display 114 (reflective or passthrough) operatively connected to a processor 116. The non-visible light 104 generated by the light source 102 is directed to the MEMS mirror array 114, which reflects the light to pass in a predetermined form and then ultimately through a lens for enlarging the pattern 110 ultimately formed on the object 112.

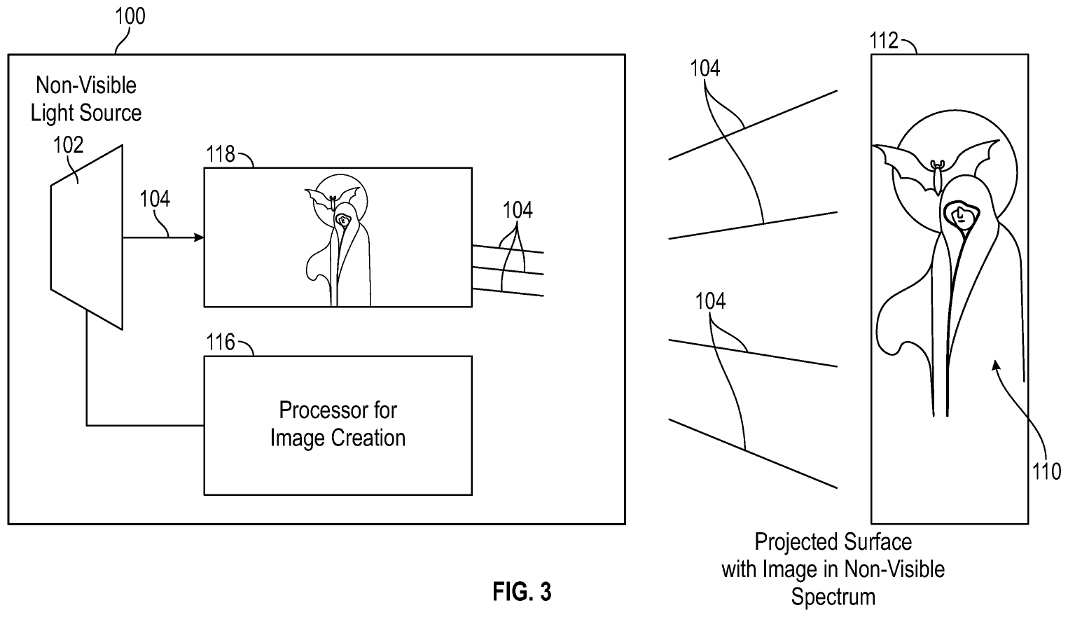

Referring to FIG. 3, a schematic diagram of an imaging alteration device 100 is shown in accordance with the present disclosure. Similar to the device 100 of FIG. 2, the device 100 of FIG. 3 includes a light source 102 configured to generate light 104 in a spectrum not visible to the human eye and a gobo 106. The device 100 further includes a liquid crystal display (“LCD”) 118 operatively connected to the processor 116. The non-visible light 104 generated by the light source 102 is directed to the LCD 118, which allows the light 104 to pass toward the gobo 106 which itself allows the light to pass in a predetermined form and then ultimately through a lens for enlarging the pattern 110 ultimately formed on the object 112.

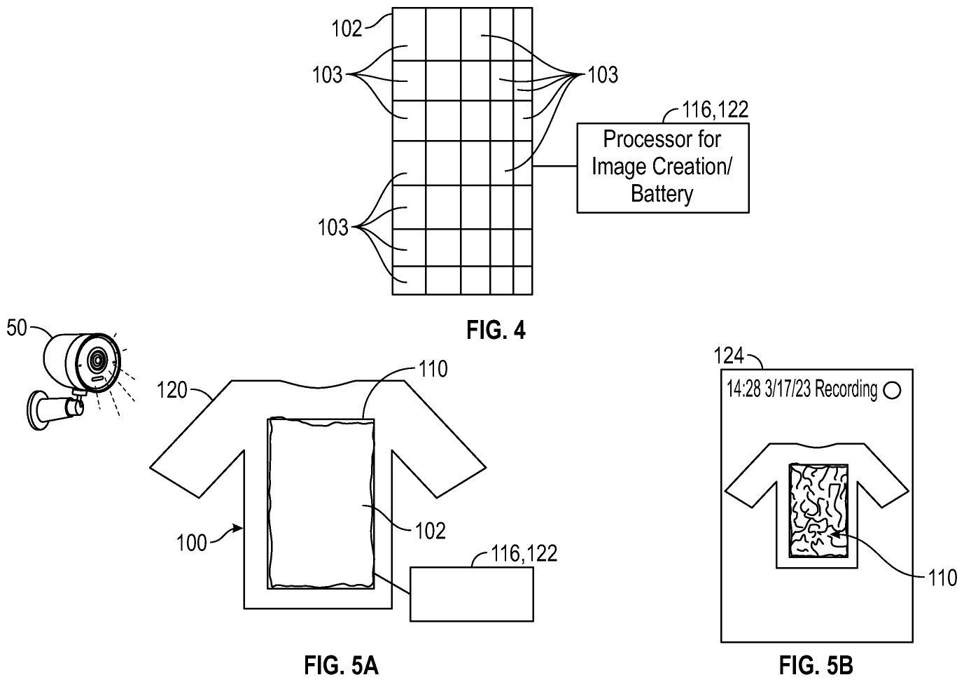

Referring to FIG. 4, a schematic diagram of an imaging alteration device 100 is shown in accordance with the present disclosure. The device 100 includes a light source 102 operatively connected to a processor 116 with battery 122. The light source 102 is a light emitting diode (“LED”) array matrix having a plurality of individual LEDs 103. Each LED 103 is individually controllable by the processor 116. While the light source 102 is shown as an LED array matrix, any light source type having the ability to selectively generate non-visible spectrum light within an array or predefined pattern is within the scope of the present disclosure. While the device 100 is shown and described with a dedicated battery 122, it is within the scope of the present disclosure for the device 100 to be connected to an external power source (e.g. the grid, line voltage). The device 100 shown in FIG. 4 does not require any lens since the LED array matrix 102 is controlled by the processor 116 to individually, selectively turn on or off certain LEDs 103 for forming the desired predetermined pattern 110. The processor 116 may be configured to dynamically change the pattern 110. For example, the processor 116 may be configured to run a series of patterns 110 as a loop.

Referring to FIG. 5A, the imaging alteration device 100 of FIG. 4 is shown connected to an article of clothing in accordance with the present disclosure. In this embodiment, the article of clothing is a shirt 120. The imaging alteration device 100 is configured to generate and emit a light pattern 110 in a non-visible spectrum of light. Shown in FIG. 5A is an image capturing/generating device 50 (e.g. a cell phone camera, security camera, etc.) in the process of capturing/generating an image of the device 100 in operation.

Referring to FIG. 5B, an image 124 of the imaging alteration device of FIG. 5A is shown as captured by the image capturing/generating device 50. The image 124 shows the light pattern 110 generated by the imaging alteration device 100 as captured by the image capturing/generating device that is not visible to the typical human eye.

Advantageously, the light pattern 110 generated by the device 100 may interfere or confuse recognition software that analyzes photo and/or video data for determining the presence of a person or in the implementation of facial recognition software. Thus, a user wearing the shirt 120 while the imaging alteration device 100 is operating and generating non-visible light can avoid detection or facial detection by one or more image capturing/generating devices.

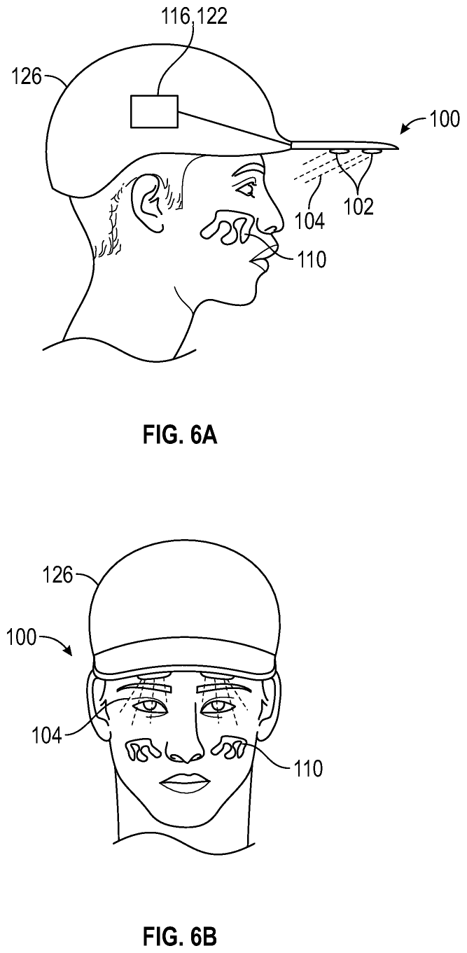

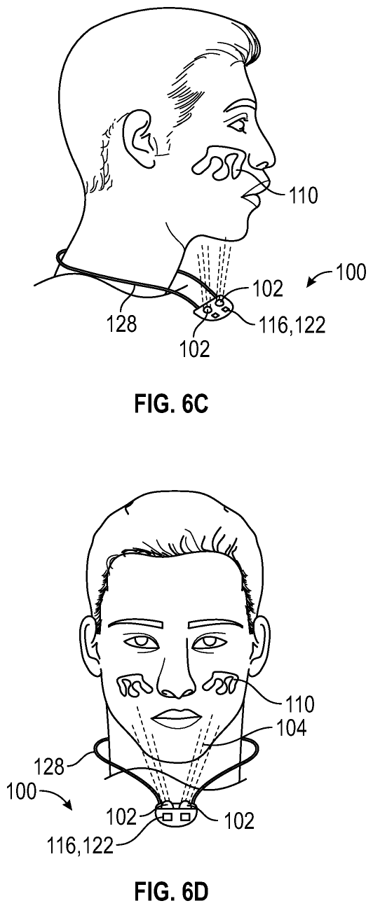

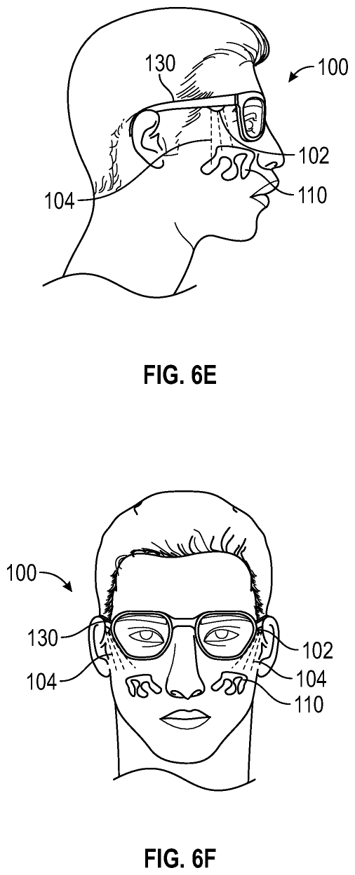

Referring to FIGS. 6A and 6B, an image capturing device 100 is shown connected to a hat 126 type article of clothing (or integrated therein) in accordance with the present disclosure. The device 100 includes a plurality of light sources 102 connected to a brim of the hat 126 and configured to generate and project non-visible light 104 onto the face of the user/wearer of the hat 126 to form a pattern 110 on the face. Additional the patterns could be projected outward towards potential cameras. These patterns could be random noise or carefully constructed images designed to confuse cameras. The plurality of light sources 102 are connected to a processor 116 for control of the light sources 102 and to a battery 122 for a power source. Instead of a plurality of light sources 102, a single light source 102 could be used.

Referring to FIGS. 6C and 6D, an image capturing device 100 is shown connected to a necklace 128 type article of clothing (or integrated therein) in accordance with the present disclosure. The device 100 of FIGS. 6C and 6D is similar to the device 100 of FIGS. 6A and 6B except that the light sources 102 project the non-visible light 104 upwards onto the face of the user/wearer. The processor 116 and battery 122 are arranged within a pendant of the necklace 128, but in other embodiments the processor 116 and/or battery 122 may be arranged elsewhere.

Referring to FIGS. 6E and 6F, an image generating device 100 is shown connected to an eyewear 130 type article of clothing (or integrated therein) in accordance with the present disclosure. The device 100 of FIGS. 6E and 6F is similar to the device 100 of FIGS. 6A and 6B except that the light sources 102 project the non-visible light 104 from a frame of the eyewear 130. In some embodiments, the device 100 is configured to attach to conventional eyewear.

While the devices 100 of FIGS. 6A-6F are shown as projecting the non-visible light 104 onto the face of the user, in some embodiments the light sources 102 are pointed away from the user and the non-visible light 104 is projected into the user's environment generally. In this manner, cameras that capture images of the user/wearer will be interfered with the non-visible light when capturing or generating an image of the user/wearer.

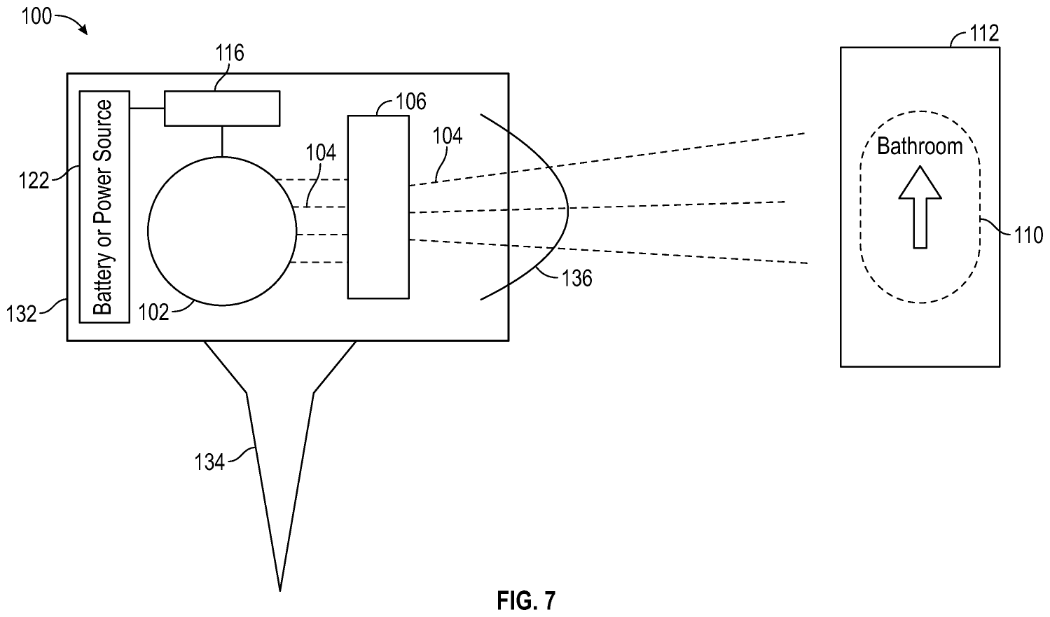

Referring to FIG. 7, a schematic diagram of an imaging alteration device 100 is shown in accordance with the present disclosure. The device 100 includes a light source 102 configured to generate light 104 in a spectrum not visible to the human eye and a gobo 106 or LCD 118. The light source 102 is electrically connected to a battery or power source 122 and is operatively connected to a processor 116. The light source 102, gobo 106 (or LCD 118), processor 116 and battery/power source 122 are housed in an enclosure 132. The enclosure 132 is connected to a mount 134, which in the shown embodiment is a ground stake. However, the mount 134 may be virtually any known form of mounting structure or mechanism such as, for example, suction cup(s), magnet(s), tripod, hook and loop fastener (e.g. Velcro), hooks, adhesives, etc. Any mounting structure for arranging and positioning the device 100 in a desired position and/or orientation for projection of the light 104 generated by the light source 102 onto a desired object 110 and/or in a desired direction is within the scope of the present disclosure.

In this embodiment, the pattern 110 includes directions to a bathroom. In practice, the device 100 may be arranged at an event or venue for providing instructions to a user that can view the pattern 110 with their phone camera or other device. For example, at an event at a museum where bathroom locations may be far from the gathering and/or not obvious, a user can use their phone camera to view the patterns 110 projected onto walls and/or the floor in order to follow the directions. This type of viewing is similar to known augmented reality applications, but different in the sense that the information is being provided to the phone (or other device) physically in the form of non-visible light instead of through the internet or local memory.

In this embodiment, the non-visible spectrum light 104 is projected through an optional lens 136 of the enclosure 132 before being projected onto an object 112. The lens 136 may be fixed or operatively connected to the controller 116 for size and/or focus control of the pattern 110.

When the device 100 is configured to include an LCD 118 instead of a gobo 106, the processor 116 can store in local memory a particular pattern 110, or series of patterns 110, for projection. In some embodiments, the device 100 is configured to receive removable storage memory (e.g. a USB drive or SD card) for loading patterns 110, or series of patterns 110, for projection. In some embodiments, the processor 116 includes the necessary components for wireless communication with a user mobile device or the internet to a remote server for instructions and retrieval of pattern 110 information for projection.

In some embodiments, the device 100 is arranged such that the processor 116 is configured for wireless communication so that the device 100 functions to complement a security camera. For example, the device 100 could be input with instructions (from either local memory or wireless instruction signals provided to the processor 116 from a remote computer, system or server) to project the non-visible light 104 in a particular pattern 110, such as a line or grid of lines, for generating a 3D scan (photogrammetry) from the 2D camera using known distance and the distortion an object makes on the line or grid lines pattern 110. Further, the device 100 could complement a security camera by functioning as an IR illuminator but configured to selectively bright areas of low contrast while not illuminating areas of high contrast via wired or wireless communication with the security camera, NVR, DVR or computer API.

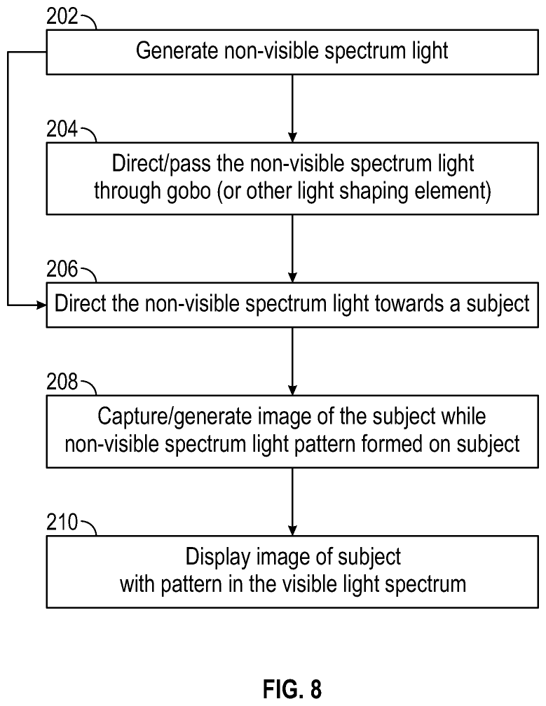

Referring to FIG. 8, a flow diagram of a method of altering an image in accordance with the present disclosure is shown. The method begins at block 202, where non-visible spectrum light is generated with a light source (e.g. light source 102). Optionally, the method proceeds to block 204, where the light is directed and/or passed through a gobo or other light shaping element such as a fixed light stencil or active light shaping apparatus (e.g. gobo 106). After optional block 204 or directly after block 202, the method proceeds to block 206 and the non-visible light is directed towards a subject to form a non-visible light pattern (e.g. pattern 110) on the subject. Then, at block 208, an image capturing/generating device (e.g. device 50) captures and generates an image of the subject while the non-visible light pattern is formed thereon. Then, at block 210, the method proceeds to display the image (e.g. image 124) of the subject with the pattern displayed and shown in the image in the visible light spectrum. The image 124 can be displayed on a display of the image capturing/generating device 50 (e.g. on a display of the cell phone camera) or can be displayed on a different display (e.g. on a TV, computer or tablet monitor).

The subject may be practically anything. For example, the subject may be a wall of a tour bus such that when passengers take photos of themselves on the bus a pattern of a logo of the tour bus company appears in their images/pictures. The subject can be a floor of a sporting arena, such as a basketball court or ice rink of a hockey game.

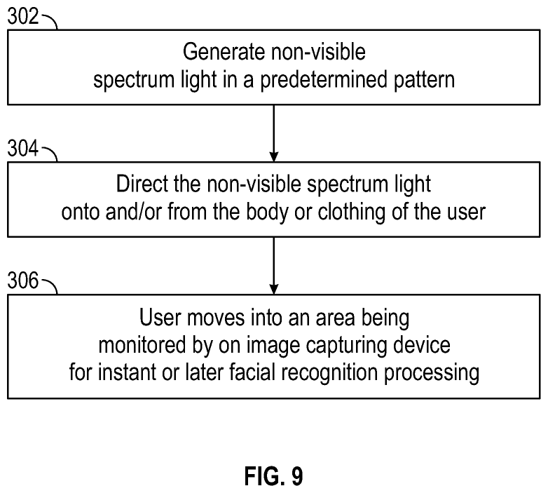

Referring to FIG. 9, a flow diagram of a method of altering an image in accordance with the present disclosure is shown. The method begins at block 302, where non-visible spectrum light is generated with a light source (e.g. light source 102) in a predetermined pattern. Then, at block 304, the method proceeds to direct the non-visible spectrum light onto and/or from the body or clothing of a user. Then, at block 306, the user moves into an area being monitored by an image capturing device for instant or later facial recognition processing while the non-visible spectrum light is being directed in block 304. Advantageously, the facial recognition processing actively occurring (or later occurring) may fail since the facial recognition processing will be interfered with and/or confused by the non-visible spectrum light pattern being generated and directed at blocks 302, 304.

Advantageously, the devices and methods of the present disclosure can be used in many different types of applications. For example and without limitation, the devices and methods of the present disclosure may be used for automobile, watercraft and/or aircraft manufacturers that desire to conceal the new design elements in the shape and body when a new product is being field tested in public. The field testers could use one or more specific wavelength filters for their own image capturing/generating devices to allow the ability to capture images without interference with the non-visible spectrum light.

Advantageously, the devices and methods of the present disclosure provide the ability for users to project their logo or other images invisibly to the human eye to create a viral social media marketing opportunity when people capture images and are surprised by the addition of details in the captured/generated image that were not apparent at the time of capturing the image.

Further, the devices and methods of the present disclosure provide the ability to counter constant surveillance and object/facial recognition at public venues. The invisible pattern projection of the present disclosure is an improvement over conventional visible pattern confusion techniques, which are very obvious and not conducive with certain societal norms. The devices and methods of the present disclosure provide a certain kind of privacy for those that do not want to be photographed and identified when at public venues without requiring a non-aesthetically pleasing outward appearance to human observers.

While the imaging alteration devices 100 of the present disclosure have been shown and described with either one light source 102 or a plurality of light sources 102, it should be readily understood that any number of light sources 102 may be utilized as desired or required. In some embodiments, the light source(s) 102 is configured to not generate any visible light.

It should be understood that the pattern 110 can be any desired pattern, graphical depiction, language, or anything that can be formed by shaping non-visible spectrum light, and is not limited to the particular patterns 110 shown in the accompanying drawings.

In some embodiments, the light source 102 and/or the processor 116 controlling the light source 102 is configured to cause the non-visible spectrum light to be generated or emitted with an adjustable wavelength and/or with multiple wavelengths. In some embodiments, the light 104 generated by the light source 102 is constantly generated such that the projection of the light 104 is continuous, or substantially continuous. In some embodiments, the light 104 generated is pulsed in short durations or varied intensities and varied durations. For example, the light 104 can be arranged to flash in short interval cycles of on and off for less than one second (e.g. 0.1 second cycles, 0.5 second cycles, etc.). Different cycle intervals are within the scope of the present disclosure. The variation of both the amplitude/intensity of the light and the duration of on/off time or time between flashes all contribute to impeding proper image capture.

It is within the scope of the present disclosure for any of the imaging alteration devices of the present application to have the necessary wiring and components to connect to an external power source, or for the devices to have their own dedicated power source, such as a battery.

Although various features have been shown in different figures for simplicity, it should be readily apparent to one of skill in the art that various features may be combined without departing from the scope of the present disclosure.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

1. A method of altering an image comprising:
generating non-visible spectrum light in the infra-red spectrum and/or in the ultraviolet spectrum;
directing the non-visible spectrum light towards a subject to form a pattern on the subject in a static manner such that an aesthetic design of the pattern is fixed;
capturing an image of the subject;
generating the image of the subject in the visible spectrum with the pattern visible in the generated image;
wherein the capturing the image of the subject comprises:
detecting the image in the visible light spectrum; and
detecting the image in the infra-red spectrum and/or in the ultraviolet spectrum; and
wherein the generating the image of the subject comprises displaying the subject with the pattern.

2. (canceled)

3. (canceled)

4. The method according to claim 1, wherein the generating the non-visible spectrum light comprises generating the non-visible spectrum light in the ultraviolet spectrum and in the infra-red spectrum.

5. The method according to claim 1, further comprising passing the non-visible spectrum light towards a gobo before the directing the non-visible spectrum light towards the subject.

6. A method of altering an image comprising:
generating a predetermined pattern with non-visible spectrum light; and
directing the non-visible spectrum light from an article of clothing of a user to an area in a static manner such that an aesthetic design of the predetermined pattern remains fixed;
capturing an image of the area;
generating the image of the area in the visible spectrum with the predetermined pattern visible in the generated image;
wherein the generating the image of the subject comprises displaying the area with the predetermined pattern.

7. The method according to claim 6, wherein the article of clothing is a shirt.

8. The method according to claim 6, wherein the article of clothing is a hat, headwear, attachment to headwear, necklace, pendant, eyewear, or attachment to eyewear.

9. The method according to claim 7, wherein a processor is operatively connected to an LED array matrix and is configured to control the LED array matrix to form the predetermined pattern with the non-visible spectrum light.

10. An imaging alteration device comprising:
an article of clothing configured to be worn by a user;
a battery connected to the article of clothing;
a light source electrically connected to the battery; and
a processor arranged to control the light source;
wherein the processor is configured to control the light source to generate a predetermined pattern with non-visible spectrum light in a static manner such that an aesthetic design of the predetermined pattern remains fixed.

11. The imaging alteration device according to claim 10, wherein the predetermined pattern is directed towards the user.

12. The imaging alteration device according to claim 11, wherein the predetermined pattern is directed away from the user.

13. The imaging alteration device according to claim 11, wherein the light source intensity is varied in durations.

14. An imaging alteration device comprising:
a housing;
a mount connected to the housing configured to arrange and position the housing in a desired position and orientation;
a battery or a power source connected to the housing;
a light source arranged within the housing configured to generate non-visible spectrum light, the light source configured to be powered by the battery or the power source;
a processor operatively connected to the light source, the processor configured to cause the light source to project the non-visible spectrum light on a subject;
wherein the processor is configured to cause the light source to project the non-visible spectrum light in predetermined pattern in a static manner such that an aesthetic design of the predetermined pattern remains fixed or to cause the light source to project the non-visible spectrum light in a predetermined series of patterns based on instructions received from local memory, local removable memory, and/or wireless signals.

15. The imaging alteration device according to claim 14, further comprising a lens, wherein the light source is configured to project the non-visible spectrum light through the lens.

16. The imaging alteration device according to claim 15, wherein the processor is operatively connected to the lens to control the size and/or focus of the pattern on the subject.

17. The imaging alteration device according to claim 14, wherein the mount is a stake.

18. The imaging alteration device according to claim 13, wherein the light source intensity is varied in cycles of less than one second.

19. The method according to claim 1, wherein the pattern is a logo.

20. The method according to claim 1, wherein the pattern includes an arrow indicating a direction.

21. The imaging alteration device according to claim 14, wherein the processor is configured to communicate with a mobile device or a remote server for instructions and retrieval of the predetermined pattern or the predetermined series of patterns.

22. The imaging alteration device according to claim 10, wherein the processor is configured to control the light source to generate the predetermined series of patterns in a loop.

23. The imaging alteration device according to claim 14, wherein the processor is configured to cause the light source to project the non-visible spectrum light in a predetermined series of patterns, the predetermined pattern being one of the patterns in the predetermined series of patterns.
